(19) United States
(12) Patent Application Publication
(10) Pub. No.: US 2015/0260429 A1
(43) Pub. Date: Sep. 17, 2015

(54) Heater comprising a co-located linear regulator and heating elements

(71) Applicant: Edward Herbert, Canton, CT (US)

(72) Inventor: Edward Herbert, Canton, CT (US)

(21) Appl. No.: 14/656,616

(22) Filed: Mar. 12, 2015

Related U.S. Application Data
(63) Continuation-in-part of application No. 61/951,580, filed on Mar. 12, 2014.

(51) Int. Cl. F24H 9/20; H05B 3/78

(52) U.S. Cl. CPC F24H 9/2014; H05B 3/78

(57) ABSTRACT

Linear regulators are inexpensive and provide excellent control with a very fast frequency response while avoiding many of the problems of pulse-width-modulated (pwm) regulators. However, they are seldom used due to their very poor efficiency. Not only do the losses in the regulator reduce the efficiency, resulting in higher energy costs, the heat in the controller is a significant problem. By co-locating the linear regulator with the heater, immersed in the medium to be heated, the losses of the linear regulator contribute to the heat to the medium, and net efficiency is nearly 100 percent. It is not necessary to co-locate the entire control, as the high dissipation likely is limited to the power transistors and only they need to be co-located with the load.

### CROSS REFERENCE TO RELATED APPLICATIONS

This application is a continuation in part of a provisional application No. 61/951,580 filed Mar. 12, 2014 entitled “Heater comprising a linear amplifier and a heating element.” Priority is claimed to its filing date, and this application is included herein by reference.

### BACKGROUND OF THE INVENTION

Most electric heaters are resistance elements, and many are controlled by on-off controls such as thermostats. Some electric range burners have controls that pulse the current on and off corresponding to a dial setting or the like without temperature feedback. More accurate controllers, like the commonly available PID controllers still usually use on-off control, though the pulses may be much shorter and more frequent.

Sometimes an analog control is used, but it almost invariably is a pulse-width-modulated (pwm) control internally, to maximize efficiency in the controller. While a pwm control may have an analog output, the internal circuitry generates significant noise, so not only is there the cost of the pwm control, there is also the cost of filtering the input and output for most uses. Usually, it would be almost unthinkable to use a true linear control due to its high losses and low efficiency.

On-off controls have several problems, one being the noise content of on-off power pulses. Another is that they tend to be on when power is restored following a power interruption, so the initial peak power is high at a time when reduced power would be better for the Grid. Collectively, with many heaters connected, this power surge is a potential problem and could cause a weak Grid to become unstable or trip out again.

### SUMMARY OF THE INVENTION

This invention teaches that a linear regulator (or at least its most dissipative components) can be co-located with the heater element and both can be immersed in the medium to be heated so that the loss in the linear regulator contributes its heat to the medium being heated.

A linear control avoids many of the problems of a pwm controller. There is no noise due to power pulsing, and turn on following a power interruption can be delayed and power can be controlled to ramp up gradually, for a soft-start.

The linear control also is enabling for some functions that are beneficial to the Smart Grid, as the power can be controlled moment by moment to accommodate the capacity of the Grid, and in particular, it can be controlled to provide regulation services by modulating the heat demand sympathetically with surges and sags on the Grid, that is, sympathetically to power noise from other loads or sources.

Heaters can be used to heat water or another medium for energy storage, drawing power during times when the supply of power is plentiful. Later, heat may be used from storage rather than from the Grid when power is in short supply. Sometime it may be desirable to schedule the power used to heat water with a time-power profile, and it is even possible to schedule the average power while still modulating it for regulation services.

While not strictly scheduling, some power sources may be intermittent such as photo-voltaic panels. Their power production is during daylight hours only, varying with the angle of the sun and cloud cover. A wind turbine provides power only when the wind blows. Such sources may have stringent loading requirements and it may be desirable or necessary to optimize power delivery from them, for example, a photo-voltaic panel with a peak-point-power algorithm. If the load is not precisely matched to the peak-power point, less than the maximum power available will be delivered. In some cases, all of the power will be delivered to the heater in just the right amount. In other cases, some power may flow elsewhere (or be sourced elsewhere) but the heater control can adjust its power input so that the net power from the PV panel is optimized. To optimize peak-power-point control, the power must be right at each instant, so an on-off heater control will not do even if its average power is correct.

Power control could also be responsive to the spot price of electricity, or to any other input parameter desired.

Linear regulation is when a control element such as a transistor conducts current to the heater with a controlled variable voltage drop so as to control the voltage on the heater and thus its power. The power losses in the linear regulator is the product of the voltage across it and the current through it, the well-known equation for power. The power in the linear regulator can be significant so the overall efficiency can be very poor.

However, if the linear element, such as the transistor, is co-located with the heater resistance element in the medium to be heated, its losses contribute to heating the medium and its power dissipation (heat) no longer is wasted. The efficiency is nearly 100 percent at any point on the range of adjustment, which can range from zero to the power of the resistance element if it were directly connected to the line voltage.

The power delivered can be regulated to maintain a constant temperature using a temperature sensor feedback and a proportional linear control, continuously varying the power by just the right amount to maintain a steady temperature. In other cases, the power may be more roughly controlled as by a potentiometer setting with no feedback. That is often the case with space heaters and electric range burners presently with on-off control, and a comparable linear control is easy to implement.

### BRIEF DESCRIPTION OF THE FIGURES

FIG. 1 shows a heater combined with the power transistors of a linear regulator. The transistors comprise an emitter-follower Darlington circuit that is responsive to a potentiometer setting.

FIG. 2 shows two heater elements combined with the power transistors of a linear regulator.

FIG. 3 shows two heater elements combined with a metal oxide silicon field effect transistor (MOSFET) as a linear regulator and a bridge rectifier.

FIG. 4 shows two heater elements combined with the power transistors of a linear regulator and a bridge rectifier further comprising a temperature sensor for feedback control.

FIG. 5 shows two heater elements combined with a MOSFET as a linear regulator and a bridge rectifier further comprising a temperature sensor and a control amplifier.

FIG. 6 shows two heater elements with the power transistors of a linear regulator. The transistors comprise an emitter-follower Darlington circuit responsive to a potentiometer setting. The input power source is direct current (dc).

FIG. 7 shows an on-demand water heater with two heater elements, a MOSFET as a linear regulator, a temperature sensor and a control amplifier responsive to the water temperature at the temperature sensor.

### DETAILED DESCRIPTION

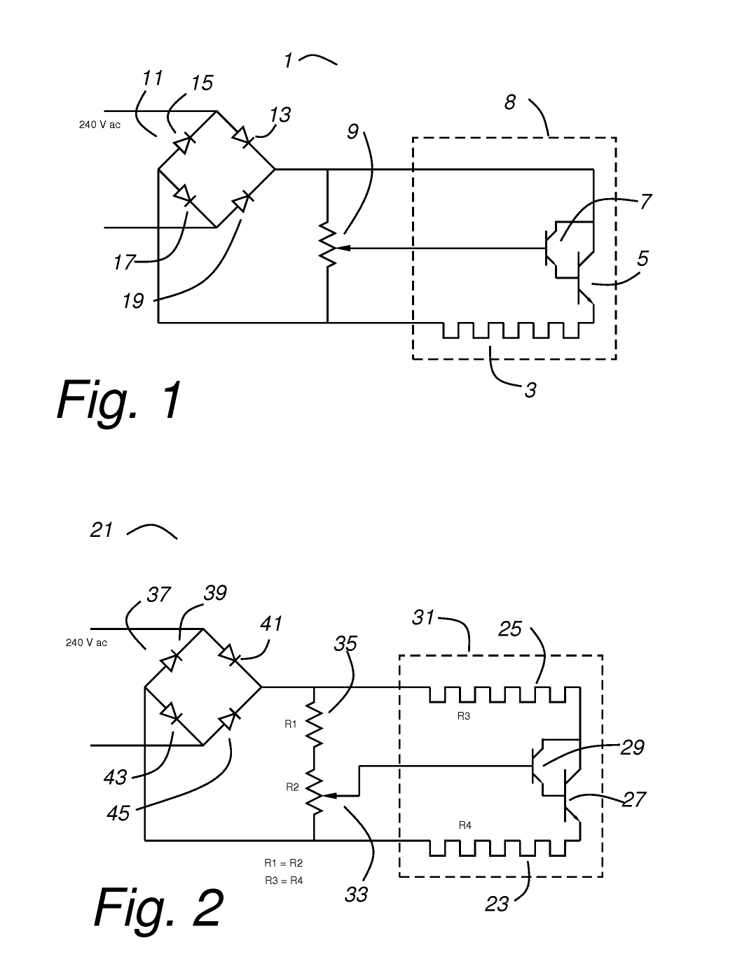

In the heating circuit 1 of FIG. 1, a heater element 3 is controlled by a Darlington pair 5,7 comprising a first transistor 5 being supplied its base drive by a second transistor 7, as would be known by one skilled in the art of transistor circuits. The base voltage of the Darlington transistor pair 5,7 is set by a potentiometer 9 so that the Darlington pair 5, 7 and the heater element 3 comprise a familiar emitter-follower circuit, controlling the voltage across the heater element 3 to be just a little lower than the base voltage of the Darlington transistor pair 5,7 (lower by the sum of the base to emitter voltage drops). This would be about 1.2 to 1.4 V for silicon NPN transistors, and may be as high as 5 to 6 V for a silicon carbide (SiC) bipolar junction transistor (SiC bjt) Darlington pair.

The input power may be 240 V ac, as an example, not a limitation. For ac excitation, a full-bridge rectifier 11 is used, and comprises rectifiers 13-19.

The heating circuit 1 of FIG. 1 does not have a precise temperature control. The heat delivered is crudely adjusted with the potentiometer 9, as would be understood by one familiar with linear regulators and, in particular, emitter follower circuits.

By using the full range of the input voltage for the potentiometer 9, the error due to the base-emitter voltage drop is less consequential. The total power is maximized when the Darlington pair 5, 7 has minimum voltage at its base, that is, when the potentiometer 9 is at the top of its adjustment range in the schematic above.

The power in the Darlington pair 5, 7 is highest when the voltage across it is half the line voltage. At that operating point, the total power of the heater circuit 1 is half of its maximum power, and the power in the heater element 3 and the Darlington pair 5, 7 are each at one fourth of maximum power.

The heater element 3 and the Darlington pair 5,7 are shown in a generic package 8 that is immersed into the medium to be heated. As will be shown in other embodiments of the invention, the entire heating circuit 1 can be immersed into the medium to be heated, but in FIG. 1 it is contemplated that the bridge rectifier 11 and the potentiometer 9 may be remotely located. The package 8 obviously must be compatible with the medium being heated. For air, a simple bracket may suffice; for water, it needs to be sealed. For other examples and embodiments, the Darlington pair 5, 7 and the heater 3 may be mounted on the back side of a plate to be a range heater. The maximum temperature must be within the operating range of the Darlington pair 5, 7, which may be in the order of 100° C. for silicon devices. Newer silicon carbide devices can operate a much higher temperatures, at least to 225° C. and as high as 500° for short duration.

FIG. 2 shows a heating circuit 21 that is similar to the heating circuit 1 FIG. 1, except that two heater elements 23 and 25 are used, and the output voltage of the emitter follower comprising a Darlington pair 27, 29 voltage is controlled to match approximately the set point voltage of a potentiometer 33. Power is contemplated as being from an ac power source, so a bridge rectifier 37 comprising rectifiers 39-45 is used to rectify the voltage. The heaters 23 and 25 and the Darlington pair 27, 29 are in an enclosure 31 that is immersed in the medium to be heated. A resistor 35 drops the voltage to the potentiometer 33 to be commensurate to the anticipated voltage on the emitter of the Darlington pair 27, 29 at full power.

Note, in both examples, the input power is full wave rectified 240 V ac voltage, so the voltage across the heater as a whole varies from 0 to 340 V, the peak voltage with an rms voltage of 240 V ac. Since the potentiometer voltage follows the same waveform, at any operating point the voltage ratio is approximately the same.

In any of these circuits the input voltage could be a dc voltage, and operation is similar, without the ripple voltage. However, many heaters are run on ac power, so a very simple control for ac voltage input is shown.

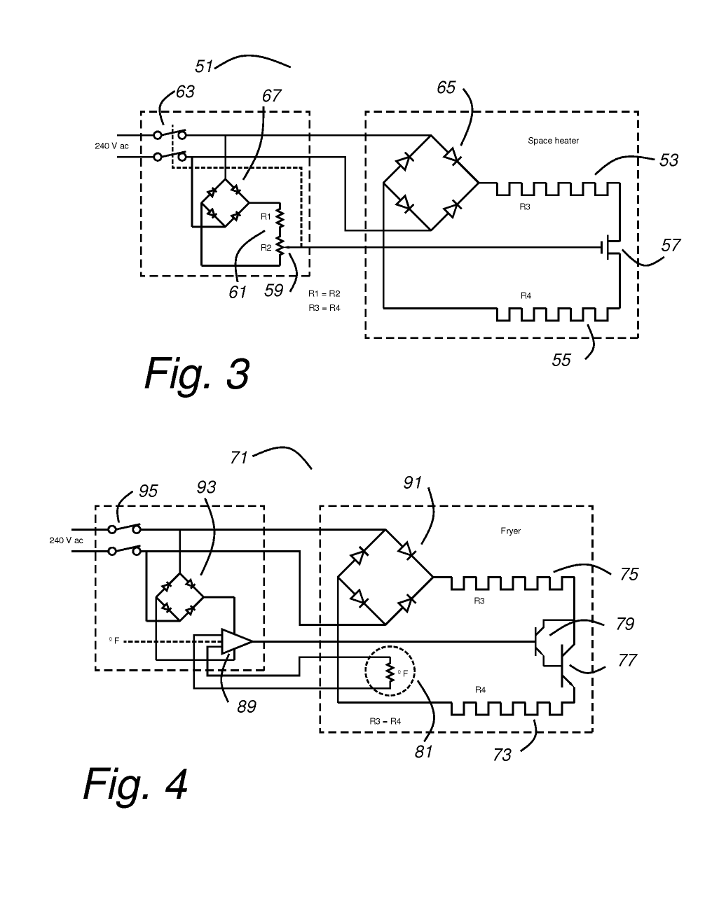

In the heater circuit 51 of FIG. 3, there is first bridge rectifier 67 for the potentiometer 59 and its series resistor 61 and a second bridge rectifier 65 for heaters 53, 55 and a MOSFET 57 regulating the power in them. The second bridge rectifier 65 for the heaters 53, 55 is packaged with them so that its losses contribute to the load and so that the first bridge rectifier 67 at the control can be much smaller. Otherwise, operation is similar to the heating circuit 21 of FIG. 2. FIG. 3 also shows a double pole switch 63, which optionally may be linked to the shaft of the potentiometer 59 as an on-off control.

For many heaters, the higher temperature capability of SiC bjts would be desirable, but the temperature of the heater elements in a space heater may be more modest. The transistor for this application could be a MOSFET, silicon for lower temperatures or SiC or GaN for higher temperatures. The MOSFET has the advantage that it draws very little gate current, essentially zero. In operation, a source-follower MOSFET circuit is very similar to an emitter-follower transistor circuit, as would be well known to one skilled in the art of transistor circuits.

As an example, a fryer operates at a temperature that may be too high for silicon MOSFETs, but it is well within the range for SiC bjts, illustrated, or, perhaps, a SiC or GaN MOSFET.

In the heater circuit 71 of FIG. 4, a temperature sensor 81 is packaged with heaters 73, 75, a Darlington pair 77, 79 and a first full-bridge rectifier 91. The temperature sensor 81 provides feedback to a control amplifier 89 so that the temperature of the heater can be controlled precisely. A second bridge rectifier 93 provides power to the control amplifier 89, and there is a double pole switch 95 to turn the input power on and off. There are many possible combinations and arrangements of temperature sensor and control amplifiers that would be well known to one skilled in the art of temperature control. The design of such circuits is not a point of novelty for this invention, so a block diagram drawing is presented. The temperature set point may be fixed, or it may be variable by adjustment or external stimuli. Again, this is optional, many different designs are possible, and it is not a point of novelty, so details are not shown.

However, while control of the power to the heaters 73, 75 and the Darlington pair 77, 79 very likely is to control the temperature at the temperature sensor 81 for normal operation, the heater circuit 71 and its control contemplates that the control amplifier 89 may implement a wide variety of control regimens under external control, and in particular, may control power in response to conditions on the supply grid (perhaps a “Smart Grid”) to reduce power if power is in limited supply or must be diverted to higher priority loads. When power is restricted, the control amplifier 89 could turn off the heater circuit 71 entirely, or it may limit the power at a lower power level. The control may delay and ramp-up the power following a power outage. Lastly, a more complex algorithm could assist in voltage regulation of the supply grid by increasing the power when the voltage is higher than nominal and reducing the power when the voltage is lower than nominal. The frequency response of linear regulators is very high, so regulation services can be provided even for fast transients on the grid.

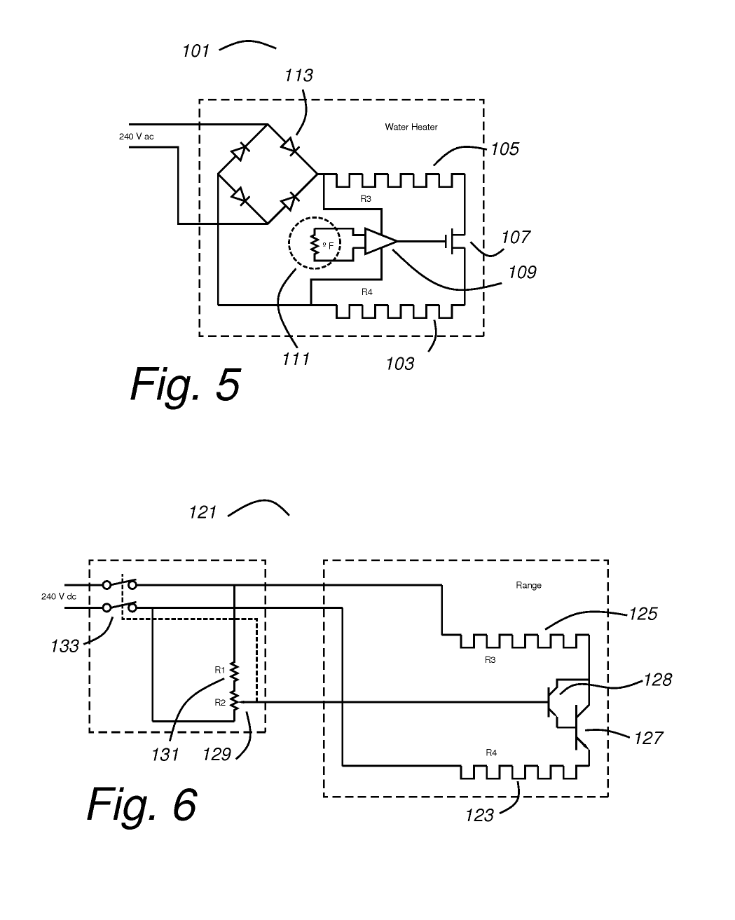

In the heater circuit 101 of FIG. 5, the entire heater circuit 101 is contemplated to be immersed in the medium to be heated. An example might be a domestic water heater with its temperature set point fixed at the factory, as an example, not a limitation. A bridge rectifier 113 provides power to heater elements 103, 105 and a MOSFET 107 as a linear regulator. A temperature sensor 111 provides an input to a control amplifier 109, which in turn, controls the gate voltage of the MOSFET 107 for linear regulation.

FIG. 6 shows a heater circuit 121 that operates from dc power, so there are no bridge rectifiers. A two pole switch 133 provides on-off control of the input power, and a potentiometer 129 with a bias resistor 131 provides a voltage signal to the base of a Darlington pair 127, 128 that regulate the power to heaters 123 and 125. It is contemplated that the heaters 123, 125 and the Darlington pair 127, 128 are immersed in the medium to be heated and the other circuit components may be remotely located as controls.

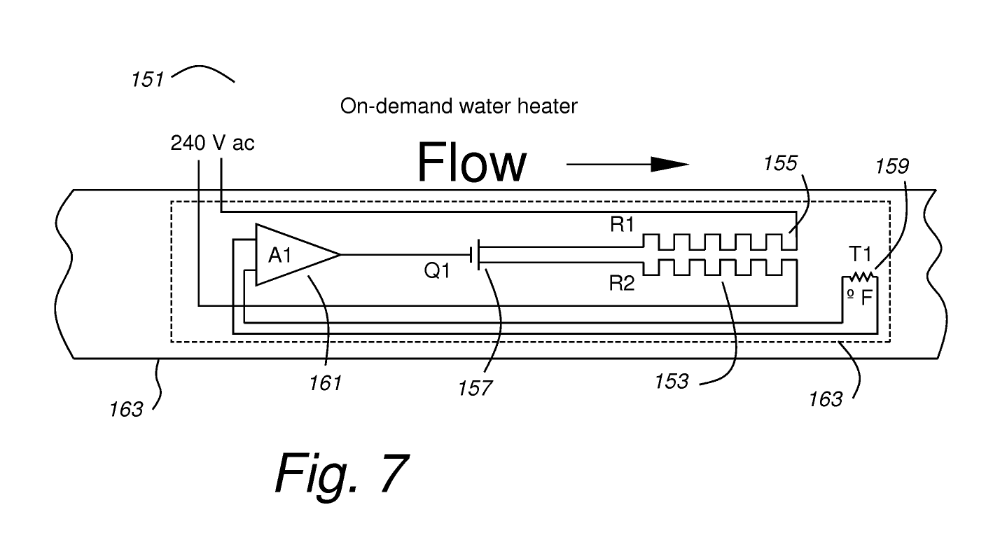

FIG. 7 shows an on-demand water heater 151 for controlling the temperature of water flowing in a pipe 165. The flow direction is indicated by an arrow designated “Flow.” The components of the on-demand water heater 151 are mounted on a heater assembly 163 which is immersed in the water, the medium to be heated. Water is an example, not a limitation, as any other fluid, liquid or gas, could be similarly heated.

A temperature sensor 159 senses the water temperature at the downstream end of the on-demand water heater 151, but a control amplifier 161 responsive to the temperature sensor 159 is on the inlet end of the on-demand water heater 151 to take advantage of the cooler water flowing there. The output of the control amplifier 161 drives the gate of a MOSFET 157, which in turn controls the power through heaters 153 and 155. The relative positions of the components considers the flow direction so that the heat increases along the length of the on-demand water heater 151 when water is flowing.

Of course, when water is not flowing, the quiescent heat will tend to equalize, so all components must be designed for long-term operation at the set-point temperature.

The temperature of an immersion heater in water is constrained by the boiling point of water. Even at elevated pressure, as in a domestic hot water heater, this is well within the operating range of silicon integrated circuits and silicon MOSFETs. Accordingly, the entire circuit is contained in the immersion heater. It may have a fixed temperature set-point, or there may be an integral or remote adjustment. There are many suitable temperature sensors and controllers, and the choice is a matter of design optimization and cost.

The surface elements and the oven element of a range get much hotter than can be accommodated with silicon parts, so the heater circuits for such applications may use a SiC Darlington pair and a SiC bridge, all mounted on the heating element. Range surface elements usually are continuously adjustable but often are not temperature controlled. A simple potentiometer control, as shown in FIGS. 2, 3 and 6, would be suitable. For an oven, or for more sophisticated surface burners, the heater may have a temper sensor, either embedded within the heater or in the nearby environment, with an external control as shown in FIGS. 4 and 5 for good temperature control at the desired set-point temperature.

A range surface element may be a heat conductive disk with a number of heaters on its lower surface, as an example. Each of the heaters is a separate resistance heater and each may have its own transistor circuit, but the bases (or gates) could be tied together for a simple common control. The number of heaters is arbitrary, and the intent is to more evenly distribute the heat while allowing the use of smaller transistors for each. Since the cost of a transistor is largely determined by its area, several small devices may be comparable in cost to one larger one while providing more even heat distribution.

In a more sophisticated range surface element, each of the heaters could have an individual temperature sensor and individual control, so that the temperature is more uniform even if a pan (a heat sink) is offset or small enough to be above only some of the heaters.

A silicon carbide disk for the range surface element would be highly desirable due to its excellent heat conductivity and chemical inertness. Other SiC composites that are less expensive, such as clay bonded SiC could be used. Some disc surface elements are cast iron or another metal. There are many suitable materials; the choice is a trade-off of the design.

Regardless, there very likely would be a maxim temperature limit in the control algorithm, for safety. Though not shown in any of the circuits, it may be advisable to have a separate independent temperature-sensitive circuit breaker as a backup in case of component failure, a common feature in domestic heaters. One consequence of using a linear regulator is that if the regulator device short circuits, or if its control fails in a high state, it will dissipate maximum power, which could be dangerous.

1. A heater for heating a medium in which the heater is immersed, comprising at least a first heating element, a linear regulator for controlling the voltage applied to the at least a first heating element to regulate the production of heat in the at least a first heating element, the linear regulator further being co-located with the at least a first heating element so that losses in the linear regulator contribute to the heating of the medium in which the heater is immersed.

2. The heater of claim 1 in which the linear regulator is a Darlington connected pair of transistors.

3. The heater of claim 1 in which the linear regulator is a MOSFET.

4. The heater of claim 1 further comprising at least a first full-bridge rectifier that is co-located with the at least a first heating element and the linear regulator.

5. The heater of claim 1 further comprising a potentiometer for controlling the linear regulator.

6. The heater of claim 1 further comprising a temperature sensor and a control amplifier for controlling the linear regulator.
